(19) United States
(12) Patent Application Publication
(10) Pub. No.: US 2007/0183882 A1
(43) Pub. Date: Aug. 9, 2007

(54) Removable stinger assembly for forklift and dolly

(76) Inventor: Gene Salazar, Napa, CA (US)

Correspondence Address: Gerald L. Robertson, 1110 Castle Oaks Drive, Napa, CA, 94558-1576, US

(21) Appl. No.: 11/349,468

(22) Filed: Feb. 6, 2006

(51) Int. Cl. B66F 9/18

(52) U.S. Cl. 414/607

(57) ABSTRACT

The preferred embodiment of the present invention comprises an adapter for use in conjunction with a conventional forklift truck comprising a mounting plate having a receiver for accepting a mating flange upon which a “stinger” is attached. A dolly for storage of said mountable stinger assembly is provided such that the stinger may be easily and safely mounted upon and removed from a forklift, resulting in portable storage of said stinger assembly which may be easily and safely moved by an individual.

### FIELD OF THE INVENTION

This invention relates to devices for the movement and transport of rolled goods, particularly a carpet roll.

### BACKGROUND OF THE INVENTION

In the fabric and carpet industries, carpet in particular, product is shipped in the form of a continuous roll to facilitate the cutting of lengths of carpet for installation which minimize the number of noticeable seams when laid. As a result, a continuous length of carpet in roll form is awkward to handle, is cumbersome in size, and requires machinery such as a forklift or fork truck in order to move it in the shipping, receiving or storage thereof.

To assist in the movement of carpet rolls, the “stinger” has been developed. A stinger is typically a length of round stock or tube steel about 9 feet in length and weighing approximately 275 pounds. The great majority of the weight of the stinger is in its base, with only perhaps 10% of the weight in the shaft of the stinger.

Many devices have been developed over the years to handle materials in rolled form. U.S. Pat. No. 5,253,972, issued Oct. 19, 1993 to Drew et al. discloses a pallet jack adapted to accept and move a heavy roll of paper. Such a device however will not be useful when the major dimension of the rolled material is the length or width of the roll, not its diameter.

U.S. Pat. No. 4,711,407 issued to Boon Dec. 8, 1987 discloses a pair of dollies each having a wheel fork. With this device, two persons are required for proper operation of the device, and the capability for loading and unloading a roll of material is not substantially enhanced.

The Miller patent, U.S. Pat. No. 4,824,313 issued Apr. 25, 1989 further discloses a pair of hand operated devices used to load a roll of material onto a truck for use in transporting said roll.

More commonly used today, a stinger is mounted to a forklift and due to its size and weight, is left mounted to the forklift for use in handling carpet rolls. The disadvantage of the present method is that due to the difficulty of mounting, dismounting and storing the stinger because of its length and weight, the stinger is left on the forklift thereby limiting the use of the forklift to handling only, for example, carpet rolls. For a smaller business which has limited capital, or for that matter, limited floor space in its shipping and receiving area, such practice creates several problems. First, in order to handle the shipping and receiving of ordinary palletted materials, a second forklift would be necessary, leaving unavailable the vehicle with the stinger attached. Forklifts are expensive pieces of equipment. Second, the forklift with the stinger occupies valuable floor space.

What is needed then, is an improved stinger assembly to permit the easy and safe mounting and removal of said stinger to a forklift. Also needed is a device which allows easier portability and storage of a stinger minimizing the potential for tying up valuable floor space.

### SUMMARY OF THE PRESENT INVENTION

It is an object of the present invention to provide an improved stinger handling device having the capability of being mounted upon and removed from a forklift. This objective is accomplished by adapting a mounting plate to which the stinger is fixed with brackets or ears which may be engaged by the forklift thereby removably fixing the stinger to the forklift.

A further objective of the present invention is to provide means for rapid mounting and removal of the stinger from the forklift. This objective is accomplished by the use of a storage dolly having a receiver on one end which is adjustable by means of a jacking mechanism, and on the other end of said dolly, a base to handle the mountable end of the stinger, said base having a stop which allows the mounting plate of the stinger to be pivoted about the upper end allowing the forklift to engage, lift and then secure the stinger thereto.

Briefly, the preferred embodiment includes a stinger having a mounting plate with an upper ear and a lower ear for engaging a forklift; a shaft fixed to said mounting plate extending outwardly therefrom; a dolly having a jacking mechanism at one end and a resting platform at the other end, said platform having a raised area thereon; said dolly having the purpose of accepting said mounting plate upon said resting platform, and further accepting said shaft into said jacking mechanism in order to store said stinger or facilitate the mounting of said stinger to said forklift.

Forklifts are typically provided with upper and lower slotted receivers for accepting forks in such a way that the forks may be spaced apart according to the load to be handled. The mounting plate of the preferred embodiment has “ears” shaped to be likewise received in the slotted receivers. The ear engages the slot either by a combination of the lifting action of the forklift and operation of the jack assembly on the dolly. The forklift is lowered such that the upper ear on the mounting plate may be engaged. With a small elevational change of the upper receiver with upper ear engaged, the stinger pivots into position such that the lower ear engages the corresponding lower receiver on the forklift. As this takes place, the dolly slides toward the forklift due to the weight shift of the stinger.

### BRIEF DESCRIPTION OF THE DRAWINGS

FIG. 1 is an side view of the preferred embodiment showing a forklift in the act of engaging the mounting plate of said stinger assembly;

FIG. 2 is a side view of the stinger assembly showing the orientation of the shaft to the mounting plate, as well as the location of the upper and lower ears;

FIG. 3 is a side view of the dolly showing the dimensional relationships of the jack mechanism, the outrigger and the resting platform with raised bead;

FIG. 4 is a frontal view of the dolly;

FIG. 5 is a top view of the dolly; and

FIG. 6 is a frontal view of the forklift illustrating the approximate location of the receivers.

### DETAILED DESCRIPTION OF THE PREFERRED EMBODIMENT

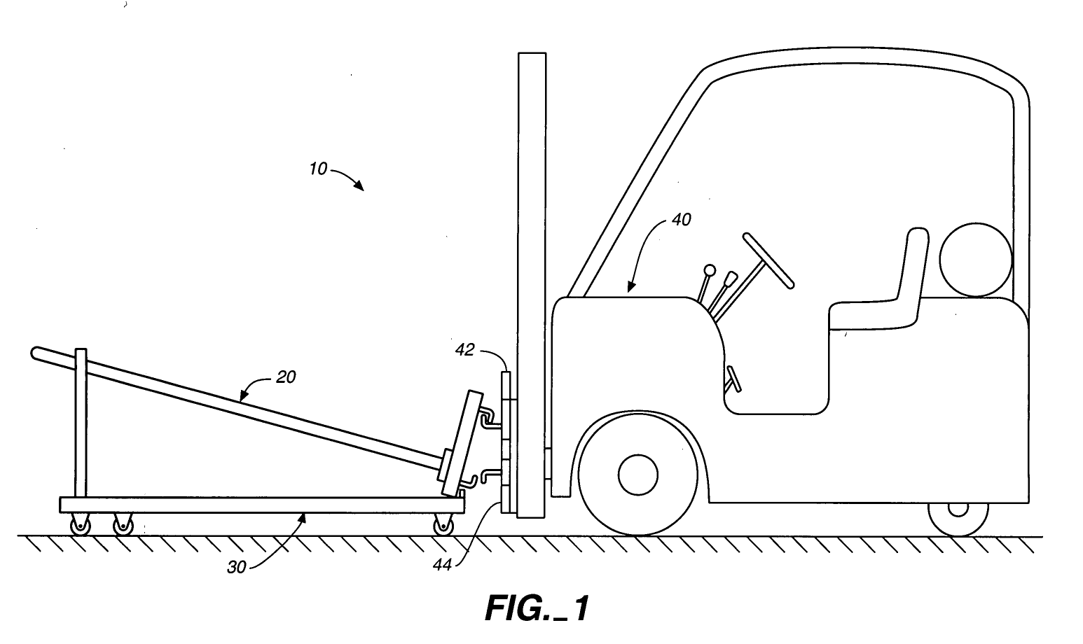

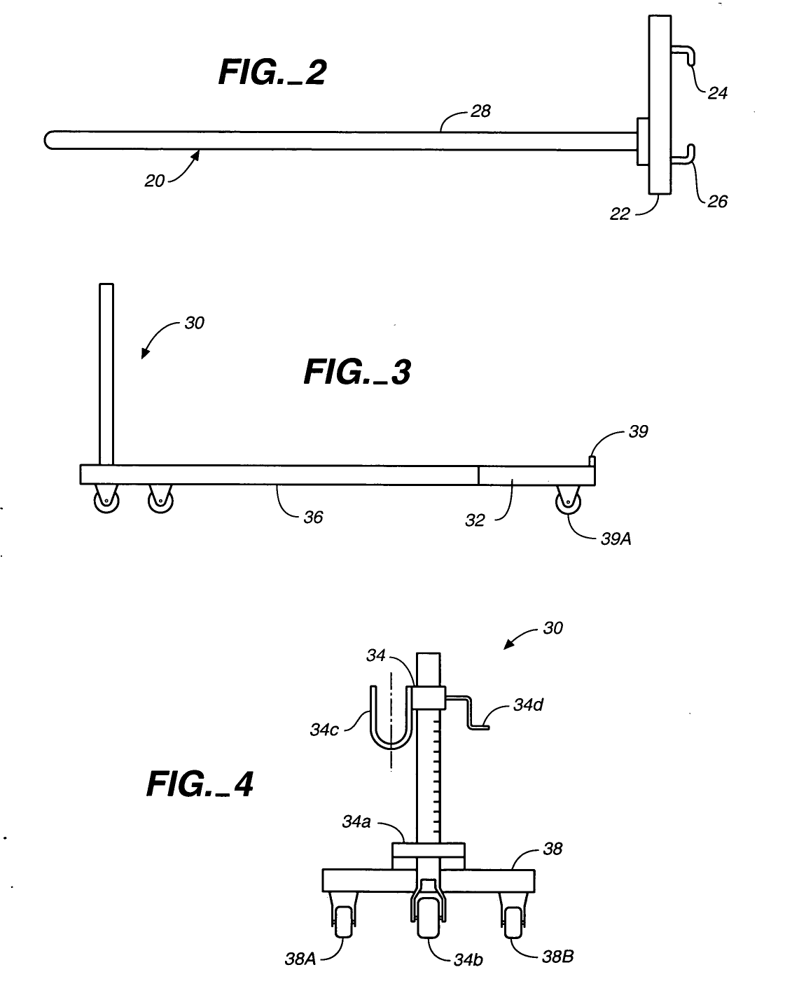

As seen in FIG. 1, the present invention, 10, comprises a stinger 20 and dolly 30. Stinger 20 is adapted to be mounted on a standard forklift, 40. Stinger 20, as can be seen from FIG. 2 comprises a mounting plate 22 having welded to it an upper ear 24 and a lower ear 26. Further welded to mounting plate 22 is a shaft 28, in a position normal to that of mounting plate 22. Shaft 28 may be fashioned from either tube material, or may be a solid metal shaft. The materials used for the shaft, mounting plate, ears, etc., must be compatible such that welding of the materials may produce a stinger of integrity and strength. Consideration of weight and the load to be manipulated must be included in deciding what materials are best suited for manufacturing stinger 20.

A dolly, 30, is shown in FIG. 3, having a resting plate 32 on one end and a jacking mechanism 34 welded to a frame portion 34a at the other end. Two struts typically of angle iron, 36, are used to connect resting plate 32 to frame portion 34a. A stiffener 37, also of angle iron. is welded to struts 36, to provide strength. Underneath frame portion 34a, upon which jacking mechanism 34 is welded, is a rotatable wheel 34b, typically approximately six inches in diameter and made of neoprene or like material.

Proximate to jacking mechanism 34 and positioned perpendicular to the longitudinal axis of dolly 30 is an outrigger 38, typically fashioned from angle iron and having at each end a two and one-half inch to three inch diameter rubber swiveling wheel, 38a and 38b. Outrigger 38 provides stability to dolly 30 which is necessary when stinger 20 is removed therefrom or placed thereon.

A weld bead 39 is provided along the edge of resting plate 32, proximate to where mounting plate 22 rests, in order to prevent stinger 20 from slipping off dolly 30 when the stinger is manipulated.

Jacking mechanism 34 is offset from the longitudinal axis of dolly 30 such that a U-shaped holder 34c is aligned thereto for holding shaft 28. A crank 34d acts to raise and lower holder 34c as herein described.

FIG. 4 shows the orientation of holder 34c along the longitudinal axis of dolly 30, as well as the structural makeup of dolly 30 in the area of jacking mechanism 34, in particular, outrigger 38.

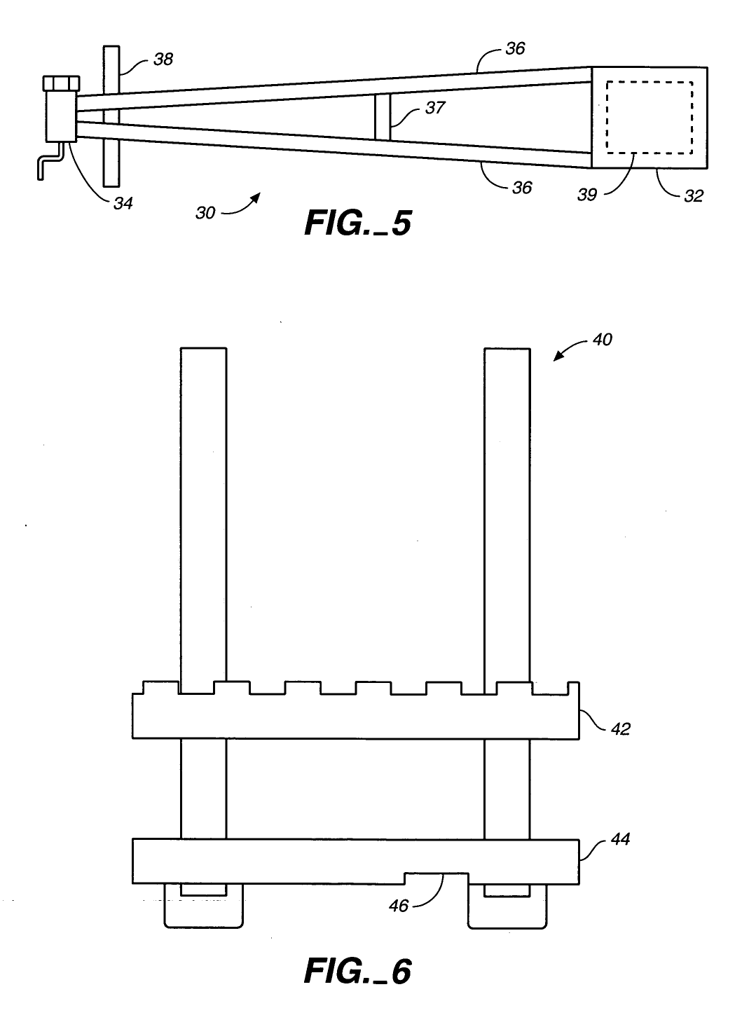

FIG. 5 discloses the dimensional relationship of the basic components of dolly 30. As seen in this figure, struts 36 project along the entire length of said dolly, and provide the structural underpinning of resting plate 32, welded thereupon. Weld bead 39 is shown as extending along an edge of resting plate 32, terminating proximate to the associated corners thereof.

FIG. 6 shows the front end of a typical forklift, 40, fitted with a slotted upper receiver 42, and a lower receiver 44. Lower receiver 44 further is slotted with a demounting slot 46.

As shown in FIG. 1, dolly 30 is positioned proximate to forklift 40, stinger 20 resting on dolly 30. In order to mount stinger 20 onto forklift 40, dolly 30 is positioned until upper and lower ears 24 and 26 are aligned with slotted portions of upper and lower receivers 42 and 44. A combination of lowering jacking mechanism 34 until mounting plate 22 is nearly vertical, and slight raising of the forklift receiver assembly lifts mounting plate 22 such that it clears weld bead 39, whereupon stinger 20 is supported by forklift 40 and may be secured thereto.

To remove stinger 20 from forklift 40, the reverse operation is performed. First, dolly 30 is positioned proximate to forklift 40 in substantial alignment under stinger 20 to support mounting plate 22 on resting plate 32, and stinger 20 is positioned with upper and lower ears 24 and 26 in substantial alignment with slotted receivers 42 and 44, particularly with lower ear 26 proximate to demounting slot 46. The forklift portion having the receivers is lowered such that shaft 28 is proximate to hook 34c. Crank 34d is operated until hook 34c engages shaft 28. As the receivers are lowered, crank 34d is operated as required to position to engage mounting plate 22 with weld bead 39, substantially freeing ears 26 and 28 from receivers 42 and 44.

Though the preferred embodiment is made as a welded metal fabrication, it is anticipated that the entire assembly could be fabricated using fasteners or their equivalent, though welded members would likely provide the greatest structural integrity.

Consequently, while the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

What is claimed is:

1. An improved stinger assembly and dolly comprising:
a mounting plate having an upper and lower ear on a first side;
a shaft extending outwardly from the second side of said mounting plate, said shaft proximate to said lower ear;
a dolly having a resting plate on one end and a frame plate on the other end, said resting plate having a weld bead thereon, and supported underneath by a wheel assembly, said frame plate having fixed thereto a jacking mechanism on its upper side had a wheel assembly attached thereunder;
a pair of rails for connecting said frame plate to said resting plate a predetermined distance therebetween, and a stiffener between said rails, fixing each of said rails to the other;
an outrigger having wheels at each end, said outrigger proximate to said jacking mechanism;
a holder attached to said jacking mechanism and means for raising and lowering said holder in order to elevate said shaft such that said mounting plate pivots against said weld bead; and
a forklift having a slotted receiver for engaging said upper and lower ears, said ears securable by means of sliding said mounting plate within said receivers.
